(19) United States
(12) Patent Application Publication
(10) Pub. No.: US 2001/0047048 A1
(43) Pub. Date: Nov. 29, 2001

(54) Fluoroelastomer composition

(75) Inventor: Satoru Saito, Kitaibaraki-shi (JP)

Correspondence Address: Russell D. Orkin, 700 Koppers Building, 436 Seventh Avenue, Pittsburgh, PA, 15219-1818, US

(73) Assignee: NIPPON MEKTRON, LTD.

(21) Appl. No.: 09/841,256

(22) Filed: Apr. 24, 2001

(30) Foreign Application Priority Data
Apr. 25, 2000 (JP) 2000-123999
Mar. 22, 2001 (JP) 2001-82847

(51) Int. Cl. C08F 214/18

(52) U.S. Cl. 524/430; 524/437; 524/443; 524/444; 524/445; 524/446; 525/326.3; 525/326.4

(57) ABSTRACT

Disclosed is a fluoroelastomer composition comprising (1) a fluoroelastomer which comprises (a) tetrafluoroethylene, (b) a perfluoro(C₁-C₅ alkyl vinyl ether) and/or a perfluoro(C₃-C₁₁ alkoxyalkyl vinyl ether) and (c) a cyano group-containing perfluorovinyl ether, (2) a hydrotalcite compound, (3) a crosslinking agent and (4) titanium dioxide (TiO₂). The fluoroelastomer composition is capable of producing a fluoroelastomer molded product having excellent metal corrosion inhibition properties, and particularly, the fluoroelastomer composition is capable of producing a fluoroelastomer molded product which generates only small amount of a corrosive material when exposed to high temperature.

### FIELD OF THE INVENTION

The present invention relates to a fluoroelastomer composition, and more particularly to a fluoroelastomer composition having excellent metal corrosion inhibition properties.

### BACKGROUND OF THE INVENTION

Molded products produced from a crosslinking fluoroelastomer composition comprising a terpolymer of tetrafluoroethylene, a perfluoro(C₁-C₅ alkyl vinyl ether) and a cyano group-containing perfluorovinyl ether and a crosslinking agent generally have very excellent heat resistance, solvent resistance and mechanical properties, so that they are used for chemical industry, aerospace industry, semiconductor industry, etc.

In Japanese Patent Laid-Open Publication No. 120144/1996, there is described a fluoroelastomer composition comprising a terpolymer of tetrafluoroethylene, a perfluoro(alkyl vinyl ether) and a cyano group-containing perfluorovinyl ether represented by the formula CF₂═CFO(CF₂)ₙOCF(CF₃)CN (n: 2-5) and as a crosslinking agent a bis(aminophenyl) compound represented by the following formula:

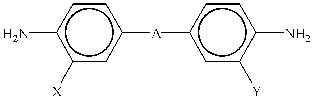

wherein A is an alkylidene group of 1 to 6 carbon atoms or a perfluoroalkylidene group of 1 to 10 carbon atoms, and X and Y are each a hydroxyl group or an amino group.

In Japanese Patent Laid-Open Publication No. 31284/1997, there is described a fluoroelastomer composition comprising a terpolymer of tetrafluoroethylene, a perfluoro (alkyl vinyl ether) and a cyano group-containing perfluorovinyl ether and as a crosslinking agent a bisamidoxime compound represented by the following formula:

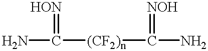

wherein n is an integer of 1 to 10.

However, when fluoroelastomer molded products obtained from these fluoroelastomer compositions are in contact with metals, the contact portion of the metals with the molded products are sometimes corroded depending upon the conditions. Especially in case of a fluoroelastomer composition containing titanium dioxide (TiO₂), the fluoroelastomer molded products undergo thermal degradation under high-temperature conditions to generate a corrosive material, and the corrosive material sometimes corrodes the metal surfaces.

It is known that metallic oxides, such as calcium hydroxide, magnesium oxide, zinc oxide and lead oxide, are added to a fluoroelastomer in order to inhibit generation of a corrosive material during the processing stage or the practical use (see U.S. Pat. No. 5,696,189).

However, even if the metallic oxides are added to the fluoroelastomer, corrosion of metals during the practical use cannot be inhibited sufficiently.

As a result of earnest studies to solve the above problem, the present inventor has found that a molded product of a fluoroelastomer composition comprising a specific fluoroelastomer, a hydrotalcite compound, a crosslinking agent and titanium dioxide (TiO₂) has excellent metal corrosion inhibition properties. Based on the finding, the present invention has been accomplished.

The present invention overcomes the problems found in the prior art by providing a fluoroelastomer composition capable of producing a fluoroelastomer molded product having excellent metal corrosion inhibition properties, and more particularly, a titanium dioxide-containing fluoroelastomer composition capable of producing a fluoroelastomer molded product which generates only a small amount of a corrosive material when exposed to high temperature.

### SUMMARY OF THE INVENTION

The fluoroelastomer composition according to the present invention comprises:

(1) a fluoroelastomer comprising:

(a) tetrafluoroethylene,

(b) a perfluoro(C₁-C₅ alkyl vinyl ether) and/or a perfluoro(C₃-C₁₁ alkoxyalkyl vinyl ether), and

(c) a cyano group-containing perfluorovinyl ether,

(2) a hydrotalcite compound,

(3) a crosslinking agent, and

(4) titanium dioxide (TiO₂).

The crosslinking agent is preferably a compound represented by the following formula (I):

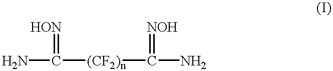

wherein n is an integer of 1 to 10.

### DETAILED DESCRIPTION OF THE INVENTION

The fluoroelastomer composition of the invention is described in detail hereinafter.

The fluoroelastomer composition of the invention comprises:

(1) a fluoroelastomer comprising:

(a) tetrafluoroethylene,

(b) a perfluoro(C₁-C₅ alkyl vinyl ether) and/or a perfluoro(C₃-C₁₁ alkoxyalkyl vinyl ether), and

(c) a cyano group-containing perfluorovinyl ether,

(2) a hydrotalcite compound,

(3) a crosslinking agent, and

(4) titanium dioxide (TiO₂).

### Fluoroelastomer (1)

The fluoroelastomer (1) for use in the invention is a terpolymer of:

(a) tetrafluoroethylene,

(b) a perfluoro(C₁-C₅ alkyl vinyl ether) and/or a perfluoro(C₃-C₁₁ alkoxyalkyl vinyl ether), and

(c) a cyano group-containing perfluorovinyl ether

As the fluoroelastomer, preferably used is one obtained by copolymerizing the tetrafluoroethylene (a) in an amount of 50 to 75% by mol, preferably 60 to 75% by mol, the perfluoro (C₁-C₅ alkyl vinyl ether) and/or the perfluoro (C₃-C₁₁ alkoxyalkyl vinyl ether) (b) in an amount of 49.8 to 25% by mol, preferably 39.8 to 25% by mol, and the cyano group-containing perfluorovinyl ether (c) in an amount of 0.2 to 5% by mol, preferably 0.5 to 2% by mol, based on 100% by mol of the fluoroelastomer.

The perfluoro (C₁-C₅ alkyl vinyl ether) employable as the component (b) is a perfluoro(alkyl vinyl ether) wherein the number of carbon atoms in the alkyl group is 1 to 5, and examples thereof include perfluoro(methyl vinyl ether), perfluoro(ethyl vinyl ether) and perfluoro(propyl vinyl ether). Of these, perfluoro(methyl vinyl ether) is preferable.

The perfluoro (C₃-C₁₁ alkoxyalkyl vinyl ether) employable as the component (b) is a perfluoro(alkoxyalkyl vinyl ether) wherein the number of carbon atoms in the side chain is 3 to 11, that is, a perfluoro(alkoxyalkyl vinyl ether) wherein the total number of carbon atoms in the alkoxyl group and the alkyl group is 3 to 11, and examples thereof include compounds represented by the following formulas.

CF2═CFOCF₂CF(CF₃)OCₙF₂ₙ₊₁ (n: 1-5)

CF₂═CFO(CF₂)₃OCₙF₂ₙ₊₁ (n: 1-5)

CF₂═CFOCF₂CF(CF₃)O(CF₂O)ₘCₙF₂₊₁ (n: 1-5, m: 1-3)

CF2═CFO(CF₂)₂OCₙF₂ₙ₊₁ (n: 1-5)

The component (b) can be used singly or in appropriate combination.

The cyano group-containing perfluorovinyl ether (c) provides crosslinked site unit, and for example, a compound represented by the following formula is employed.

CF₂═CFO(CF₂)ₙOCF(CF₃)CN (n: 2-4)

Other examples of the cyano group-containing perfluorovinyl ethers (c) employable in the invention include:

a compound represented by the following formula:

CF₂═CFO(CF₂)ₙCN (n: 2-12)

(that is described in U.S. Pat. No. 3,546,186);

a compound represented by the following formula:

CF₂═CFO(CF₂CF(CF₃)O)ₘ(CF₂)ₙCN (n: 2, m:1-5)

(that is described in U.S. Pat. No. 4,138,426);

a compound represented by the following formula:

CF₂═CFO(CF₂CF(CF₃)O)ₘ(CF₂)ₙCN (n: 1-4, m:1-2)

(that is described in U.S. Pat. No. 4,281,092);

and

a compound represented by the following formula:

CF₂═CFO(CF₂CF(CF₃)O)ₙCF₂CF(CF₂)CN (n: 0-4)

(that is described in U.S. Pat. No. 3,852,326 and Pat. No. 3,933,767).

### Hydrotalcite Compound (2)

The hydrotalcite compound (2) for use in the invention is a compound represented by the formula (Mg)ₓ(R)_{y}(OH)_{z}CO₃.nH₂O (R: Al, Cr or Fe, x: 4-6, y: 2, z: 12-18, n:0-4).

As the hydrotalcite compound, a compound represented by the formula Mg_{4.5}Al₂(OH)₁₃CO₃.3.5H₂O is preferably employed.

A compound obtained by calcining the above compound to remove water of crystallization can also be preferably employed.

The hydrotalcite compound is used in an amount of 0.2 to 10 parts by weight, preferably 0.5 to 5 par-Ls by weight, based on 100 parts by weight of the fluoroelastomer.

If the amount of the hydrotalcite compound is smaller than 0.2 part by weight, metal corrosion inhibition properties sufficient for a molded product of the resulting composition are not obtained in some cases. If the amount thereof is larger than 10 parts by weight, heat resistance and solvent resistance of a molded product of the fluoroelastomer composition are sometimes lowered.

### Crosslinking Agent (3)

As the crosslinking agent (3) for use in the invention, any compound capable of crosslinking the fluoroelastomer is adoptable, but preferably used is a compound represented by the following formula (I):

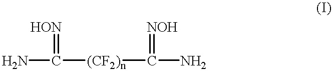

wherein n is an integer of 1 to 10.

The crosslinking agent is used in an amount of 0.1 to 5 parts by weight, preferably 0.5 to 3 parts by weight, based on 100 parts by weight of the fluoroelastomer (1).

### Titanium Dioxide (4)

As the titanium dioxide (TiO₂) (4) for use in the invention, any of rutile type titanium dioxide, anatase type titanium dioxide and amorphous titanium dioxide is adoptable, but the rutile type titanium dioxide is preferably used from the viewpoint of heat resistance.

The titanium dioxide (4) is used in an amount of 0.1 to 50 parts by weight, preferably 0.3 to 10 parts by weight, based on 100 parts by weight of the fluoroelastomer (1).

If the amount of the titanium dioxide is smaller than 0.1 part by weight, the opacifying power is insufficient and bad appearance of the finally obtained molded product is sometimes induced. If the amount thereof is larger than 50 parts by weight, lowering of mechanical properties and heat resistance is sometimes induced.

### Fluoroelastomer Composition

The fluoroelastomer composition of the invention contains the fluoroelastomer (1), the hydrotalcite compound (2), the crosslinking agent (3) and titanium dioxide (4) as essential components, and to such a fluoroelastomer composition of the invention, inorganic fillers, such as aluminum oxide, silicon dioxide, calcium silicate, aluminum silicate, magnesium silicate, barium sulfate, barium titanate and barium carbonate, can be appropriately added.

The composition can be prepared by, for example, mixing the above components at a temperature of 20 to 100° C., preferably 30 to 80° C., using a two-roll mill. The fluoroelastomer composition can be molded into a desired shape such as a shape of o-ring by means of a compression molding machine or the like. The molding temperature is in the range of 150 to 250° C., preferably 170 to 220° C., and the molding time is in the range of 5 to 60 minutes, preferably 5 to 30 minutes.

To enhance the properties of the molded article, it is preferable to subject the molded product of the composition to oven vulcanization in an inert atmosphere or air at a vulcanization temperature of 150 to 320° C., preferably 200 to 300° C., for a vulcanization time of 10 to 50 hours.

The fluoroelastomer composition of the invention provides a vulcanized molded product having excellent metal corrosion inhibition properties. The composition of the invention is favorably applied particularly to uses where the composition is in contact with a metal and is exposed to severe conditions such as temperature conditions of not lower than 150° C.

The molded product of the composition has excellent chemical resistance, and hence it also exhibits sufficient resistance to severe environments where various conditions, such as contact with metals, high-temperature conditions and highly reactive liquids act on the molded product in a complicated manner.

### EXAMPLE

The present invention is further described with reference to the following examples, but it should be construed that the invention is in no way limited to those examples.

### Example 1

Fluoroelastomer

In accordance with a known process (Japanese Patent Laid-Open Publication No. 120144/1996), 69.0% by mol of tetrafluoroethylene, 30.3% by mol of perfluoro(methyl vinyl ether) and 0.7% by mol of perfluoro(1-cyano-6-oxa-7-octene) were copolymerized to prepare a fluoroelastomer. The polymer Mooney Viscosity of the fluoroelastomer at 150° C. was 77.1 pts

Preparation of Composition

100 Parts by weight of the fluoroelastomer thus obtained, 1 part by weight of 2,2,3,3,4,4,5,5-octafluorohexanediamidoxime (available from Nippon Mektron Ltd.) as a crosslinking agent, 10 parts by weight of titanium dioxide (Tipaque™ CR-93 (trade name), available from Ishihara Sangyo Kaisha, Ltd.) and 2 parts by weight of a hydrotalcite compound (DHT-4A™ (trade name), available from Kyowa Kagaku K.K.) were kneaded at a temperature of 40 to 60° C. using a two-roll mill to obtain a composition. The composition was subjected to compression molding at a temperature of 190° C. for a molding time of 15 minutes to obtain a crosslinked product.

The crosslinked product was then subjected to oven vulcanization in air under the following conditions.

That is, the crosslinked product was heated from room temperature to 204° C. over a period of 3 hours, then held at 204° C. for 10 hours, then heated from 204° C. to 288° C. over a period of 3 hours and then held at 288° C. for 18 hours.

The molded product of the fluoroelastomer composition was subjected to the following cured product property test and corrosion test to evaluate hardness, tensile strength, elongation, compression set and metal corrosion inhibition properties. The results are set forth in Table 1.

Test Methods

(1) Cured Product Property Test

The hardness, tensile strength, elongation and compression set were evaluated by the following methods.

Hardness: DIN53505

Tensile strength and elongation: DIN53503

Compression set: ASTM D395, Method B (AS568A214 O-ring), at 275° C. for 70 hours

(2) Metal Corrosion Test

In accordance with a method of SUS304, a 214 O-ring was sandwiched between metal plates (each: 50×50×2 mm), and they were compressed by 3% of the linear diameter of the O-ring. The metal plates and the O-ring in this state were heated in an oven at 300° C. for 48 hours. After the heating, the metal plates were separated from the O-ring, and corrosion of the metal portion formerly sealed with the O-ring was visually observed and evaluated based on the following criteria.

AA: Corrosion was not observed.

BB: Corrosion was observed.

CC: Marked corrosion was observed.

### Example 2

A fluoroelastomer composition was prepared in the same manner as in Example 1, except that titanium dioxide was used in an amount of 1 part by weight, the hydrotalcite compound was used in an amount of 0.5 part by weight, and silicon dioxide (Aerosil™ 200 (trade name), available from Degussa Co.) was used in an amount of 8 parts by weight. The fluoroelastomer composition was molded in the same manner as in Example 1 to obtain a molded product. The molded product was subjected to a cured product property test and a corrosion test in the same manner as in Example 1 to evaluate hardness, tensile strength, elongation, compression set and metal corrosion inhibition properties. The results are set forth in Table 1.

### Comparative Example 1

A fluoroelastomer composition was prepared in the same manner as in Example 1, except that the hydrotalcite compound was not used. The fluoroelastomer composition was molded in the same manner as in Example 1 to obtain a molded product. The molded product was subjected to a cured product property test and a corrosion test in the same manner as in Example 1 to evaluate hardness, tensile strength, elongation, compression set and metal corrosion inhibition properties. The results are set forth in Table 1.

### Comparative Example 2

A fluoroelastomer composition was prepared in the same manner as in Example 1, except that 2 parts by weight of zinc oxide (Zinc White No. 1™ (trade name), available from Sakai Kagaku K.K.) was used in place of the hydrotalcite compound. The fluoroelastomer composition was molded in the same manner as in Example 1 to obtain a molded product. The molded product was subjected to a cured product property test and a corrosion test in the same manner as in Example 1 to evaluate hardness, tensile strength, elongation, compression set and metal corrosion inhibition properties. The results are set forth in Table 1.

### Comparative Example 3

A fluoroelastomer composition was prepared in the same manner as in Example 1, except that the titanium dioxide was used in an amount of 1 part by weight, the hydrotalcite compound was not used, and silicon dioxide (Aerosil™ 200 (trade name), available from Degussa Co.) was used in an amount of 8 parts by weight. The fluoroelastomer composition was molded in the same manner as in Example 1 to obtain a molded product. The molded product was subjected to a cured product property test and a corrosion test in the same manner as in Example 1 to evaluate hardness, tensile strength, elongation, compression set and metal corrosion inhibition properties. The results are set forth in Table 1.

TABLE 1

| | Ex- | Ex- | | | |
|---|---|---|---|---|---|
| | am- | am- | Comp. | Comp. | Comp. |
| | ple | ple | Ex. | Ex. | Ex. |
| | 1 | 2 | 1 | 2 | 3 |
| Components of composition | | | | | |
| (part(s) by weight) | | | | | |
| Fluoroelastomer | 100 | 100 | 100 | 100 | 100 |
| Crosslinking agent | 1 | 1 | 1 | 1 | 1 |
| Titanium dioxide | 10 | 1 | 10 | 10 | 1 |
| Hydrotalcite compound | 2 | 0.5 | — | — | — |
| Zinc oxide | — | — | — | 2 | — |
| Silicon dioxide | — | 8 | — | — | 8 |
| Molding temperature (° C.)/ | 190 (° C.)/15 (min) | | | | |
| Monding time (min) | | | | | |
| Oven vulcanization | * | * | * | * | * |
| Properties of molded products | | | | | |
| Ordinary state value | | | | | |
| Hardness (pts) | 68 | 79 | 66 | 72 | 79 |
| Tensile strength (Mpa) | 5.3 | 22.3 | 10.9 | 14.2 | 21.3 |
| Elongation (%) | 140 | 150 | 200 | 140 | 160 |
| Compression set | 32 | 35 | 26 | 47 | 26 |
| (275° C./70 hr) | | | | | |
| Metal corrosion test | AA | AA | CC | CC | BB |
| (300° C./48 hr) (SUS304) | | | | | |

* in air room temperature → 204° C. (3 hr)
204° C. (10 hr)
204 ˜ 288° C. (3 hr)
288° C. (18 hr)

What is claimed is:

1. A fluoroelastomer composition comprising:
(1) a fluoroelastomer which comprises:
(a) tetrafluoroethylene,
(b) a perfluoro(C₁-C₅ alkyl vinyl ether) and/or a perfluoro(C₃-C₁₁ alkoxyalkyl vinyl ether), and
(c) a cyano group-containing perfluorovinyl ether,
(2) a hydrotalcite compound,
(3) a crosslinking agent, and
(4) titanium dioxide.

2. The fluoroelastomer composition as claimed in claim 1, wherein the crosslinking agent is a compound represented by the following formula (I): 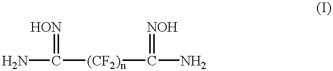
wherein n is an integer of 1 to 10.
